(19) United States
(12) Patent Application Publication
(10) Pub. No.: US 2016/0040504 A1
(43) Pub. Date: Feb. 11, 2016

(54) Suction Nozzle

(71) Applicant: Calvin J. Stowe, Bellaire, TX (US)

(72) Inventor: Calvin J. Stowe, Bellaire, TX (US)

(73) Assignee: BAKER HUGHES INCORPORATED, Houston, TX (US)

(21) Appl. No.: 14/454,958

(22) Filed: Aug. 8, 2014

(51) Int. Cl. E21B 37/00; B05B 1/00; E21B 41/00

(52) U.S. Cl. CPC E21B 37/00; E21B 41/0078; B05B 1/00

(57) ABSTRACT

A system, method and apparatus for cleaning a wellbore is disclosed. A workstring is conveyed in a wellbore. A jet sub provided associated with the wellbore, wherein the jet sub includes at least one nozzle, the nozzle including: a nozzle body; a bore formed in the nozzle body, the bore having an outlet; and a plurality of inlet jets disposed tangentially about the bore and opposite the outlet of the bore. A completion fluid is provided to the at least one nozzles via the work string and jet sub. The completion fluid is expelled via the at least one nozzles.

### BACKGROUND

1. Field of the Disclosure

The present invention is related to a suction nozzle and, in particular, a suction nozzle to remove obstructions in a wellbore.

2. Background of the Art

Various downhole operations, such as perforating zones for production, continued production, etc., create debris and particles that circulate, embed, and occlude the perforations of the production zones or other flow channels. In certain applications, such debris and particles negatively affect flow characteristics and flow rates of formation fluids. Cleaning operations may be performed to remove debris from perforations or other flow channels. However, most current wellbore cleaning apparatuses, including traditional nozzles, further embed a portion of mineral deposits and debris, diminishing the effectiveness of the cleaning operation. Accordingly, the use of current wellbore cleaning apparatuses, often leads to slow and incomplete cleaning operations.

### SUMMARY OF THE DISCLOSURE

In one aspect, the present disclosure provides a nozzle including a nozzle body; a bore formed in the nozzle body, the bore having an outlet; a closed end, and a plurality of inlet jets disposed tangentially about the bore near the closed end.

In another aspect, the present disclosure provides a wellbore cleaning system including work string; and a jet sub containing at least one cleaning device, wherein the at least one cleaning device includes: a nozzle body; a bore formed in the nozzle body, the bore having an outlet; a closed end, and a plurality of inlet jets disposed tangentially about the bore near the closed end.

Examples of certain features of the apparatus and method disclosed herein are summarized rather broadly in order that the detailed description thereof that follows may be better understood. There are, of course, additional features of the apparatus and method disclosed that will form the subject of the appended claims.

### BRIEF DESCRIPTION OF THE DRAWINGS

This disclosure is best understood by the accompanying figures: FIG. 1 shows a downhole system that includes a wellbore cleaning system for removing debris and particles in an exemplary embodiment of the disclosure;

FIG. 2A shows an isometric view of the cleaning tool of the wellbore cleaning system of FIG. 1 for use in removing debris and particles in an exemplary embodiment of the present disclosure;

FIG. 2B shows a side elevation view of the cleaning tool of the wellbore cleaning system of FIG. 1 for use in removing debris and particles in an exemplary embodiment of the present disclosure;

FIG. 2C shows a bottom elevation view of the cleaning tool of the wellbore cleaning system of FIG. 1 for use in removing debris and particles in an exemplary embodiment of the present disclosure;

FIG. 3A shows an side elevation view of the nozzle of the cleaning tool of FIG. 2A for use in removing debris and particles in an exemplary embodiment of the present disclosure;

FIG. 3B shows a front elevation view of the nozzle of the cleaning tool of FIG. 2A for use in removing debris and particles in an exemplary embodiment of the present disclosure;

FIG. 3C shows an side elevation view of the nozzle of the cleaning tool of FIG. 2A for use in removing debris and particles in an exemplary embodiment of the present disclosure illustrating exemplary flow paths; and

FIG. 3D shows a front elevation view of the nozzle of the cleaning tool of FIG. 2A for use in removing debris and particles in an exemplary embodiment of the present disclosure illustrating exemplary flow paths.

### DETAILED DESCRIPTION OF THE EMBODIMENTS

FIG. 1 shows a wellbore cleaning system 100 for cleaning wellbore 104 and particularly perforations 118 in an exemplary embodiment of the disclosure. The wellbore cleaning system 100 includes a work string 112 disposed in a wellbore 104 formed in a formation 102. The work string 112 extends in the wellbore 102 from a surface location 108 to a downhole location 110. A cleaning tool 114 is conveyed by the work string 112. The tool 114 may be coupled to a flow control device 120 via work string 112. Flow control device 120 controls the flow 122 through work string 112 and tool 114 to control the cleaning output of tool 114. In various embodiments, the flow control device 120 may be at a surface location 108 or at a suitable location in the work string 112.

The wellbore cleaning tool (also referred to as a jet sub) 114 is conveyed to a selected depth of the wellbore 104 by the workstring 112. In certain embodiments, the wellbore cleaning tool 114 is conveyed to be adjacent to perforations 118. Perforations 118 may contain obstructions, such as mineral deposits, or other contaminants that restrict, impede, or stop the flow of formation fluids. Due to the positive pressure differential between the formation and wellbore, traditional nozzles directing a flow towards the formation, or outwardly toward the walls of the wellbore are not effective, and further push obstructions into the formation 102, further impeding the flow of perforations 118.

The tool 114 includes one or more nozzles 116 to facilitate flow of a cleaning fluid flow 122 in such a manner to create a localized suction from a positive pressure flow 122 that is applied adjacent to perforations 118 to clear obstructions and debris within the wellbore 104 and particularly within perforations 118. In certain applications, the application of a localized suction will cause the obstruction to disintegrate as many obstructions found in perforations 118 have a low tensile strength. Further, the removal of such obstructions is assisted by the positive pressure differential between the formation 102 and the wellbore 104.

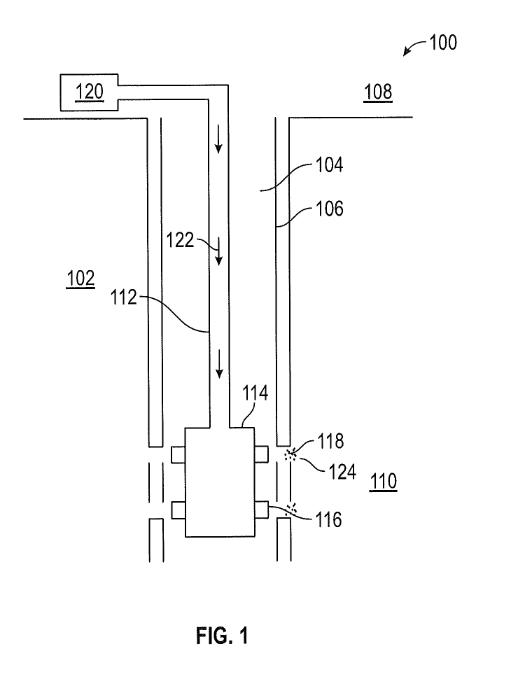

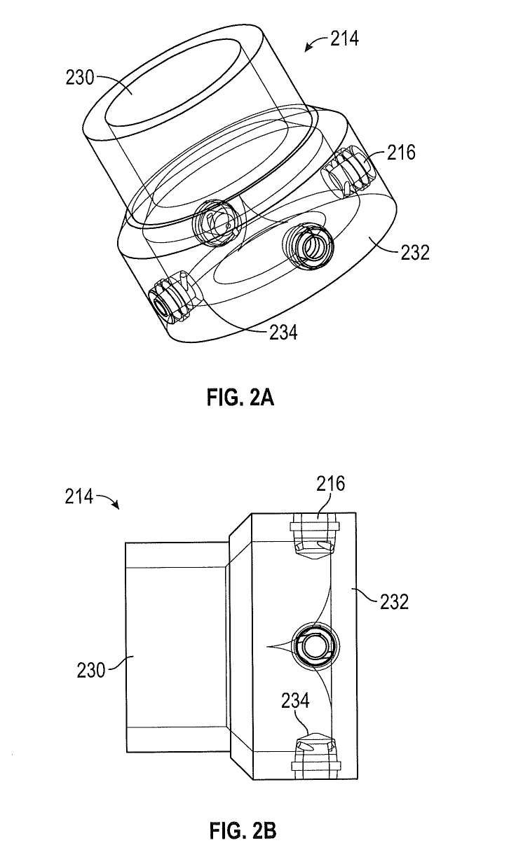

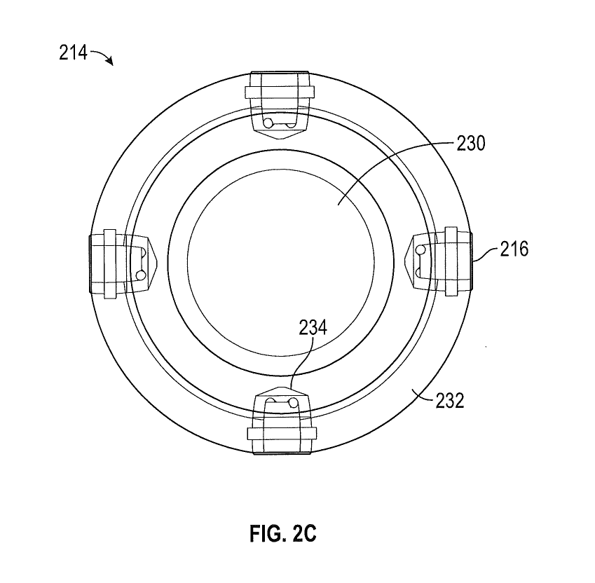

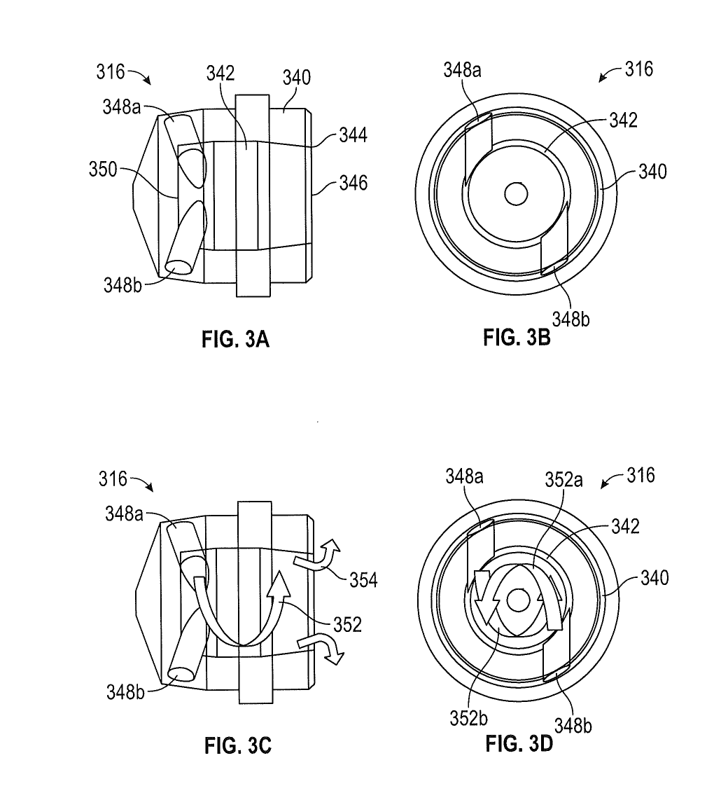

The exit flow from nozzles 116 is a vortex which flows radially outward a distance from the nozzle exit. This outward flow creates a local low pressure area within the vortex. When the nozzle is positioned such that a perforation 118 is within the low pressure zone, the negative pressure differential between the wellbore 104 and the formation 110 exerts a force on any obstruction plugging the hole, and stimulates flow to effect removal of substances partially obscuring the opening. This mechanism is particularly desirable as the negative pressure only occurs near the nozzle 116, and pressure returns to ambient a short distance away. This eliminates risk of uncontrolled formation fluid flow through openings 118 during the cleaning operation. Though the invention is directed at clearing passages, the intense suction produced is anticipated to also be effective in cleaning surface deposits on the interior wall of the casing 106, by creating a negative pressure differential between the surface of the deposit facing the wellbore 104 and the back side of the deposit adjacent to the casing 106. Tool 114 is translated within the wellbore 104 and rotated to ensure cleaning of the wellbore 104 and perforations 118. Fluid flow 122 includes completion fluid such as salt water with polymer particulate, mud, or produced fluids. Details of the tool 114 and nozzle 116 are discussed below with respect to FIGS. 2 and 3.

FIGS. 2A-C show an exemplary cleaning tool 214, (also referred to as a jet sub) suitable for cleaning wellbore 104 and perforations 118. The cleaning tool 214 includes nozzles 216, bore 230, and mounting ring 232. Tool 214 is formed of any suitable material, particularly a material suitable to withstand the environment of wellbore 104. The tool 214 has a generally cylindrical shape with a bore 230 formed therethrough. Bore 230 allows for flow 122 of a cleaning fluid or completion fluid to flow from a work string 112 out into the wellbore 104 via nozzles 216. Nozzles 216 are mounted to mounting ring 232 via any suitable means, such as threaded or other mechanical fastening means. Flow 122 is received by nozzles 216 from bore 230 via openings 234 in mounting ring 232. The inlets of nozzles 216 are in fluid communication with openings 234 to receive flow 122 from bore 230.

FIGS. 3A and B show an exemplary nozzle suitable for use with exemplary cleaning tool 214. The nozzle 316 includes body 340, inlets 348a,348b, bore 342, and outlet 346. Nozzle body 340 is made of any suitable material, particularly any material that withstands the environment of wellbore 104. Inlets 348a,348b and outlet 346 are formed within the body 340 and bore 342 to allow flow 122 therethrough. Inlets 348a, 348b receive flow 122 from bore 230 of tool 214. Inlets 348a,348b direct flow 122 into bore 342. After flow 122 passes through bore 342, the flow 122 exits the nozzle 316 though outlet 346.

The nozzle body 340 contains a discrete bore 342 within the body 340. In alternative embodiments, bore 342 is formed within body 340. The bore 342 extends through a substantial portion of body 340 and is generally cylindrical. At one end, bore 342 receives flow 122 from inlets 348a,348b and an at opposite end, expels flow 122 at outlet 346. In exemplary embodiments, the bore 342 is tapered near the outlet 346. In certain embodiments, the bore 342 is tapered at both ends, or may retain straight walls. The taper is from 0 to 15 degrees. In an exemplary embodiment, the taper is no more than 10 degrees. In certain applications, the use of a taper with bore 342 accelerates the output speed of flow 122 through outlet 346 The relative length of bore 342 is short compared to the diameter of bore 342. In certain embodiments, the ratio of the length of the bore 342 to the diameter of the bore 342 is less than 3 to 1. In an exemplary embodiment, the ratio of the length of the bore 342 to the diameter of the bore 342 is no greater than 2 to 1. Advantageously, a relatively low length to diameter ratio allows flow speed to remain high to ensure an adequate pressure drop.

Inlets 348a, 348b are disposed opposite from the outlet 346 of bore 342. In an exemplary embodiment, nozzle 316 has two inlets 348a, 348b. In alternative embodiments, nozzle 316 has at least two inlets, but may have more. Inlets 348a,b receive flow 122 from bore of tool 214. Inlets 348a, 348b are disposed tangentially about bore 342 to promote a swirl or vortex flow. In exemplary embodiments, inlets 348a, 348b are inclined at least one degree to reduce interference and crossing of flow and further promote swirl and vortex.

After flow 122 is received in the bore 342 from the inlet 348a,348b, the vortex like flow flows outwardly to outlet 346. As previously stated, the taper of bore 342 accelerates the flow 122 as the flow 122 exits nozzle 316.

FIGS. 3C and 3D illustrate representative flows through nozzle 316. The tangential, inclined inlets 348a,348b allow for a vortex or swirl 352 to form within the bore 342. As flow 352 reaches outlet 346, flow 352 moves outward tangentially to bore 340 to form outlet flow 354. The area between outlet flow 354 creates a cavitation void. The cavitation void creates a localized low pressure area that creates the desired suction.

Accordingly, the created suction allows for debris to be effectively removed from perforations 118. After the debris is dislodged, flow 354 moves the debris away from the cavitation void and the perforations 118. The geometry and characteristics of the nozzle 316 described allows for a high speed flow to be created, which consequently allows for a substantial suction. In certain embodiments, the nozzle 316 has an efficiency of at least 80% for a given input pressure. In exemplary embodiments, the nozzle 316 has provided at least 90% efficiency. Furthermore, well control is maintained as the suction created by nozzle 316 is easily controlled and localized with a 1″ by 1″ area directly in front of the outlet 346 of the nozzle 316.

Therefore in one aspect, the present disclosure provides a nozzle including a nozzle body; a bore formed in the nozzle body, the bore having an outlet; and a plurality of inlet jets disposed tangentially about the bore and opposite the outlet of the bore. In various embodiments, the bore is a tapered bore. Further, in certain embodiments, the tapered bore has a taper angle no greater than 10 degrees. In various embodiments, the plurality of inlet jets are inclined toward the outlet of the bore. In certain embodiments a ratio between a length of the bore and a diameter of the bore is no greater than 2 to 1.

In another aspect, the present disclosure provides a wellbore cleaning system including work string; and a jet sub containing at least one cleaning device, wherein the at least one cleaning device includes: a nozzle body; a bore formed in the nozzle body, the bore having an outlet; and a plurality of inlet jets disposed tangentially about the bore and opposite the outlet of the bore. In various embodiments, the bore is a tapered bore. Further, in certain embodiments, the tapered bore has a taper angle no greater than 10 degrees. In various embodiments, the plurality of inlet jets are inclined toward the outlet of the bore. In certain embodiments a ratio between a length of the bore and a diameter of the bore is no greater than 2 to 1. In certain embodiments, the plurality of inlet jets is two inlet jets.

In another aspect, the present disclosure provides a method for cleaning a wellbore, including conveying a work string in a wellbore; providing a jet sub associated with the wellbore, wherein the jet sub includes at least one nozzle, the nozzle including: a nozzle body; a bore formed in the nozzle body, the bore having an outlet; and a plurality of inlet jets disposed tangentially about the bore and opposite the outlet of the bore; providing a completion fluid to the at least one nozzles via the work string and jet sub; and expelling the completion fluid via the at least one nozzles. In various embodiments, the bore is a tapered bore. Further, in certain embodiments, the tapered bore has a taper angle no greater than 10 degrees. In various embodiments, the plurality of inlet jets are inclined toward the outlet of the bore. In certain embodiments a ratio between a length of the bore and a diameter of the bore is no greater than 2 to 1. In exemplary embodiments, a suction is created. Further, in certain embodiments, the suction created has an efficiency of at least 80% for a given input pressure. In certain embodiments, the suction created is localized within a bore diameter of the outlet of the bore. In certain embodiments, the plurality of inlet jets is two inlet jets.

While the foregoing disclosure is directed to the certain exemplary embodiments of the disclosure, various modifications will be apparent to those skilled in the art. It is intended that all variations within the scope and spirit of the appended claims be embraced by the foregoing disclosure.

What is claimed is:

1. A nozzle comprising:
a nozzle body;
a bore formed in the nozzle body, the bore having an outlet; and
a plurality of inlet jets disposed tangentially about the bore and opposite the outlet of the bore.

2. The nozzle of claim 1, wherein the bore is a tapered bore.

3. The nozzle of claim 2, wherein the tapered bore has a taper angle no greater than 10 degrees.

4. The nozzle of claim 1, wherein the plurality of inlet jets are inclined at least one degree toward the outlet of the bore.

5. The nozzle of claim 1, wherein a ratio between a length of the bore and a diameter of the bore is no greater than 2 to 1.

6. The nozzle of claim 1, where the plurality of inlet jets is two inlet jets.

7. A wellbore cleaning system comprising:
a work string; and
a jet sub containing at least one cleaning device, wherein the at least one cleaning device includes:
a nozzle body;
a bore formed in the nozzle body, the bore having an outlet; and
a plurality of inlet jets disposed tangentially about the bore and opposite the outlet of the bore.

8. The system of claim 7, wherein the bore is a tapered bore.

9. The system of claim 8, wherein the tapered bore has a taper angle no greater than 10 degrees.

10. The system of claim 7, wherein the plurality of inlet jets are inclined at least one degree toward the outlet of the bore.

11. The system of claim 7, wherein a ratio between a length of the bore and a diameter of the bore is no greater than 2 to 1.

12. The system of claim 7, wherein the plurality of inlet jets is two inlet jets.

13. A method for cleaning a wellbore, comprising:
conveying a work string in a wellbore;
providing a jet sub associated with the wellbore, wherein the jet sub includes at least one nozzle, the nozzle including:
a nozzle body;
a bore formed in the nozzle body, the bore having an outlet; and
a plurality of inlet jets disposed tangentially about the bore and opposite the outlet of the bore;
providing a completion fluid to the at least one nozzles via the work string and jet sub; and
expelling the completion fluid via the at least one nozzles.

14. The method of claim 13, wherein the bore is a tapered bore.

15. The method of claim 14, wherein the tapered bore has a taper angle no greater than 10 degrees.

16. The method of claim 13, wherein the plurality of inlet jets are inclined at least one degree toward the outlet of the bore.

17. The method of claim 13, wherein a ratio between a length of the bore and a diameter of the bore is no greater than 2 to 1.

18. The method of claim 13, further comprising creating suction.

19. The method of claim 18, wherein the suction created has an efficiency of at least 80% for a given input pressure.

20. The method of claim 18, wherein the suction created is localized within a bore diameter of the outlet of the bore.

21. The method of claim 13, where the plurality of inlet jets is two inlet jets.
